(19) United States
(12) Patent Application Publication
(10) Pub. No.: US 2011/0068581 A1
(43) Pub. Date: Mar. 24, 2011

(54) Rotating Doors Wind Machine

(76) Inventor: Jerry Lowery, Irvington, AL (US)

(21) Appl. No.: 12/563,317

(22) Filed: Sep. 21, 2009

(51) Int. Cl. F03D 9/00

(52) U.S. Cl. 290/55

(57) ABSTRACT

The rotating door wind machine is built by attaching 2 or more door units to a vertical shaft. The wind force closes the doors and create a torque on the shaft thereby causing it to rotate horizontally and produce energy. This energy is then output to drive a load such as an electrical generator. When the shafts turn 180 degrees the doors will open to allow the wind force to pass through and not interfere with the machine's rotation.

### BACKGROUND OF THE INVENTION

The present invention relates to the use of a wind machine to capture wind energy and convert it to electrical energy. Most wind machines, built in the past as well as the present, consist of huge heavy propellers mounted on a horizontal shaft extending hundreds of feet upward to extract power from high speed, wind currents. These machines are not only costly to build but also costly to erect and maintain. Most need complicated tracking and positioning systems to move the propellers in a position so as to get the maximum benefit of the winds power. They are harmful to wildlife killing and maiming thousand of them every year.

### BRIEF DESCRIPTION OF THE INVENTION

The present embodiment employs a drag system rather than a lift system. A drag system has an undesirable effect of using part of it's wind energy to over come the energy lost due to drag forces. Drag forces are negative forces acting on a machine's surfaces as it increases in speed. This is overcome in this embodiment by keeping the machine speed low as well as constant. This constant speed is the result of changing the torque on the machines load and therefore keeping the machine speed low and constant. The way that this is done is by using a DC generator with a shunt wound, variable excited, field for it's load. The variable field excitation can be supplied by two methods. One method is to have a variable power supply that is controlled by a speed feed back mounted on the generator or the drive shaft of the machine. This speed feed back is fed into a controller with a PID function. The PID function compares the speed feed back with a set point representing desired machine speed. The PID function then calculates the necessary control voltage needed to control the power supply that excites the generator field.

The other method is to use the voltage output of generator's armature to excite the field of the generator. As the machine speed tries to increase, due to the wind force increasing, it will also increase the generator's armature voltage. Part or all of the armature voltage is fed back into the generator's field thereby increasing it's torque and keeping the machine's speed constant. The opposite effect takes place when the machine speed tries to decrease due to wind force decreasing. For simplicity and ease of explanation, the latter method will be referred to in this explanation.

### BRIEF DESCRIPTION OF FIGURES

FIG. 1 is a front view of a rotating doors wind machine.

FIG. 2 is a perspective drawing of a rotating doors machine. Wheels have been added to take load off of the load bearings.

FIG. 3 is a front view of a rotating doors wind machine showing multiple door units FIG. 5 (22) added to increase its power output. The machine has wheels added to carry the extra load and for stabilization.

FIG. 4 is a top view of a wind machine. It shows how multiple door units FIG. 5 (22) can be added radially for increase power output.

FIG. 5 is a typical door unit.

FIG. 6 shows how the strong, lightweight, frame is built.

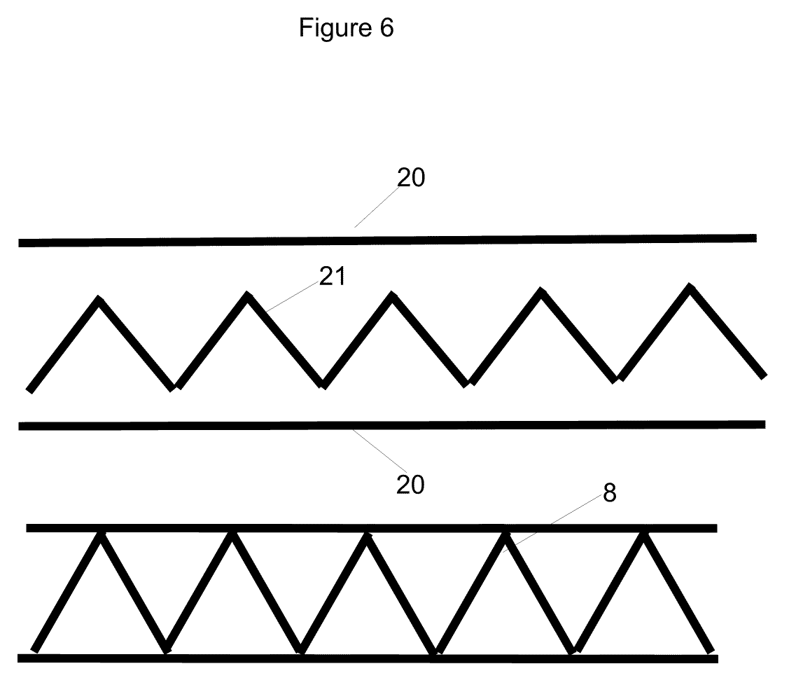

FIG. 7 is a drawing of the prototype used in the tests.

### DETAILED DESCRIPTION OF THE DRAWINGS

### Detailed Description of Drawings

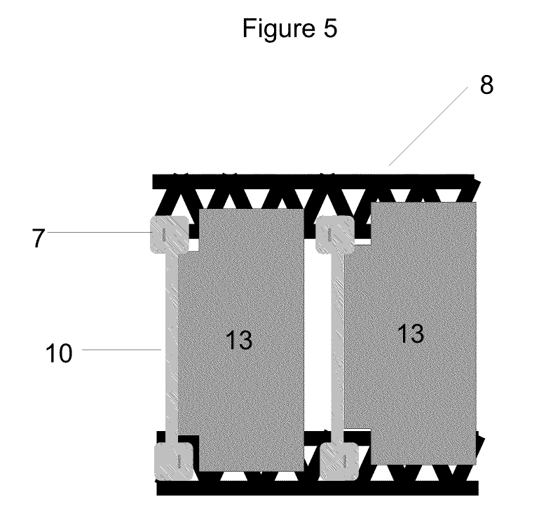

The most basic unit of the embodiment is the door unit FIG. 5. It consists of 2 lightweight doors (13) mounted on a rotating shaft (10). The shaft rotates on bearings (7). The bearings are mounted on a lightweight, truss, frame.

The truss frame FIG. 8 consist of lightweight, metal, tubing such as aluminum or EMT conduit. The center member of the truss (21) is bent into a sinusoidal design by bending the metal tubing back and forth in a conduit or pipe bender. The 2 outer members are then attached to the center member to form a strong lightweight truss.

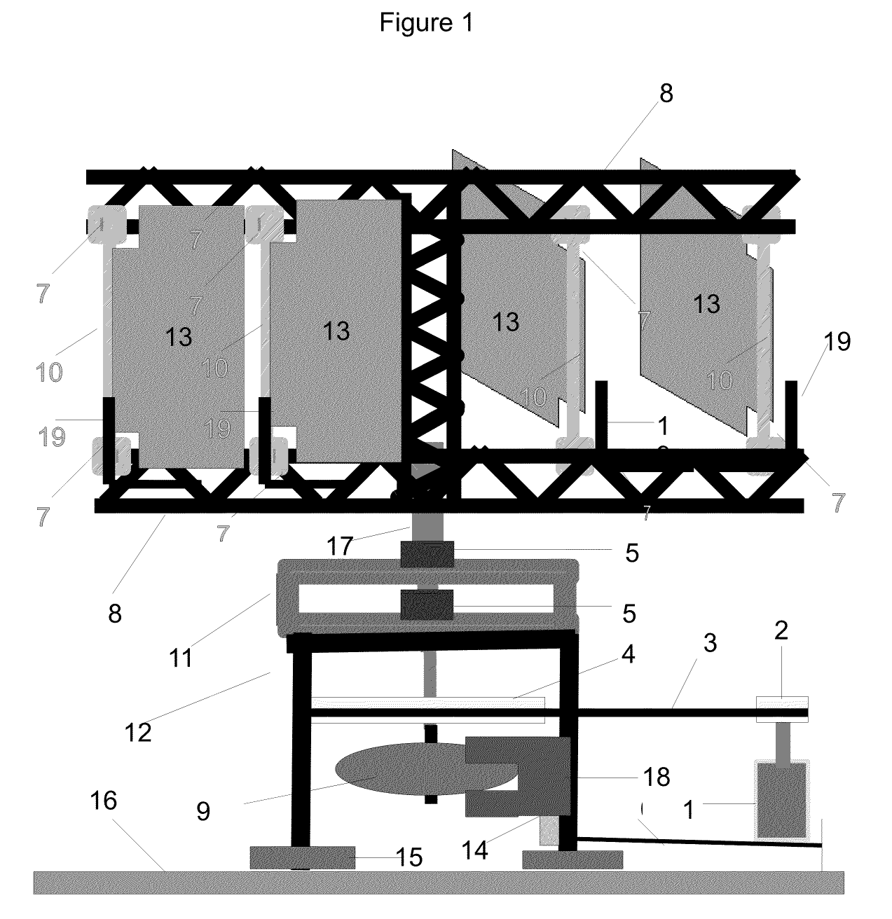

FIG. 1 is a front view of a rotating door wind machine. This drawing shows the most basic machine needed to create rotation and create usable energy. It consists of 2 door units mounted on a vertical shaft (17). The way rotation occurs is by the opening and closing of the doors (13). For example when the wind force is from a direction to cause the doors on the left side of the shaft to close it will push on the doors and create usable rotation. At the same time that the doors on the left side of the shaft are closing, the doors on the right side of the shaft are opening. This allows the wind force to pass through them and not interfere with machine's rotation.

The door stops (19) will only allow the doors to open 90 degrees. This allows maximum wind force blowthrough and takes less power to close the doors.

The load shaft sits on load bearings (15). The bearings are attached to the bearing box (11) which in turn is mounted on a truss foundation (12). The truss foundation is mounted on the floor flanges (15) which are mounted on the reinforced concrete pad (16) with anchor bolts.

The output sheave (4) is mounted on the machines drive shaft and drives the generator through the generator's belt sheave (2) and the drive belt (3). The ratio of the two sheaves is large enough to cause the generator to have a usable output. The generator could also be connected to the machine's shaft through a speed increaser gearbox.

The generator in this example has a separate excited, shunt, field. This allows the speed of the machine to be held low and constant. If the machine tries to increase in speed, the generator's field excitation will be increased. This causes an increase in load on the wind machine thereby causing the machine to run at a constant speed. In this example the generator's field is excited by using some or all of the armature voltage for field control. The field could also be controlled by a separate power source which is controlled by a controller using speed feed back.

There are several reasons for keeping the machine's speed low and constant. First, if the machine is allowed to turn too fast, the centrifugal force would increase and cause damage to the machine. Next an increase in speed would cause an increase in the drag force on the machine. Drag force is a negative force that subtracts from the power output of the machine. The third reason is for protection of wildlife. By traveling at a slow safe speed wildlife would not be harmed or killed as they are in high speed lift type machines.

The stopping of the machine is done with the braking system (6)(9)(14). The brake disc (9) is mounted on the machine's shaft. When the machine is needed to stop for maintenance or repair, the braking cable (6) is pulled. This causes the pads in the brake caliper (14) to press against the brake disc and stop the machine. The machine can then be kept from moving with cables or chains. The brake caliper is attached to the foundation.

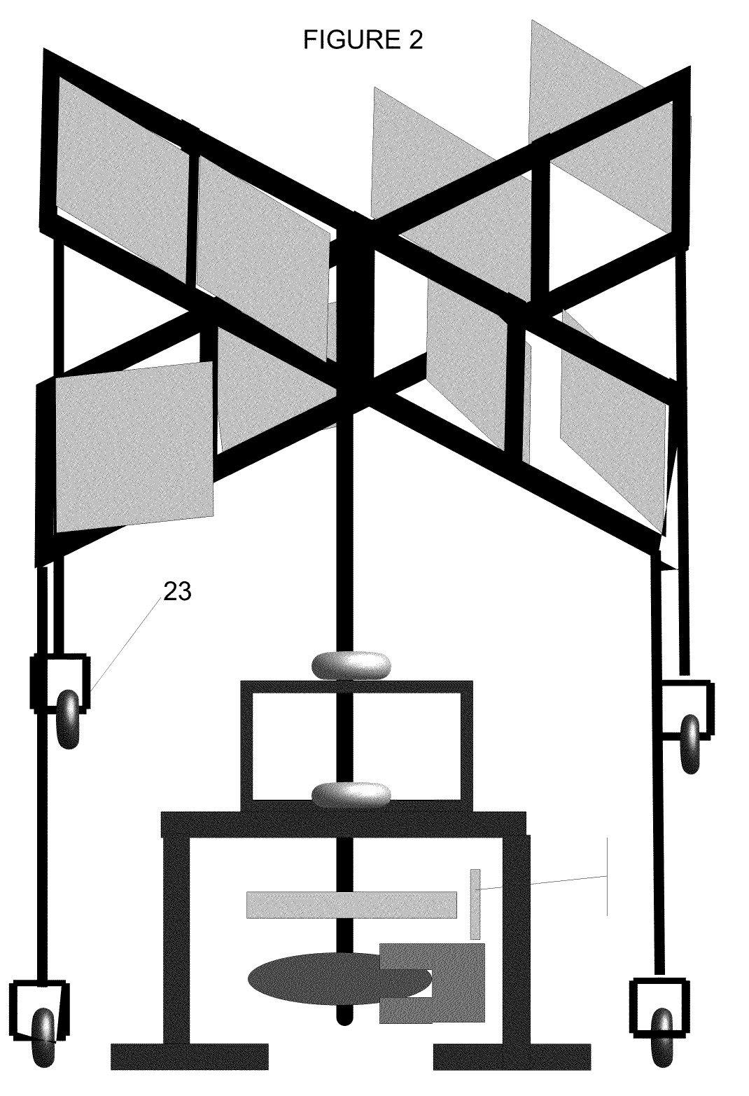

FIG. 2 shows a perspective drawing of the rotating door wind machine. It shows a machine with wheels (23) added to take some of the load off the shaft load bearings and stabilize it.

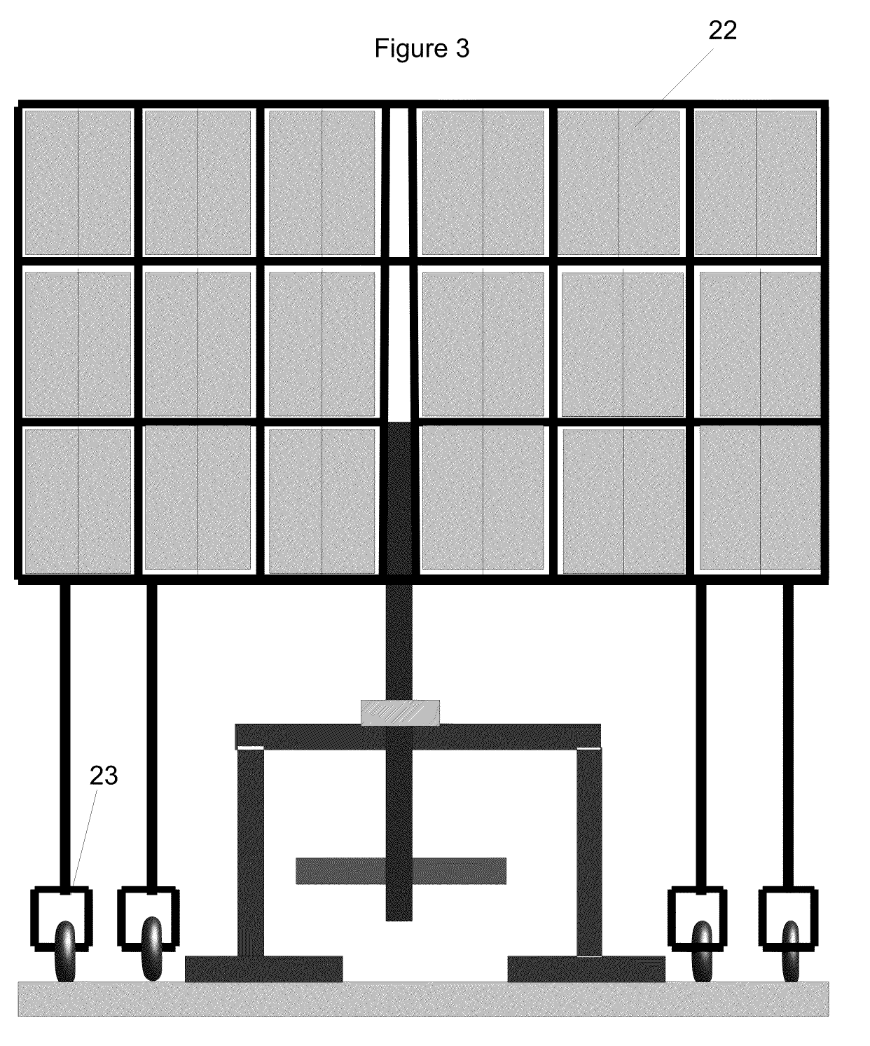

FIG. 3 is a drawing showing a front view of an expanded machine. It proves claim 10 that the power produced by the machine is proportional to it's size. The more door units added to the machine the more power the machine is capable of producing. It has wheels (23) to relieve the load on the bearings and for stabilization.

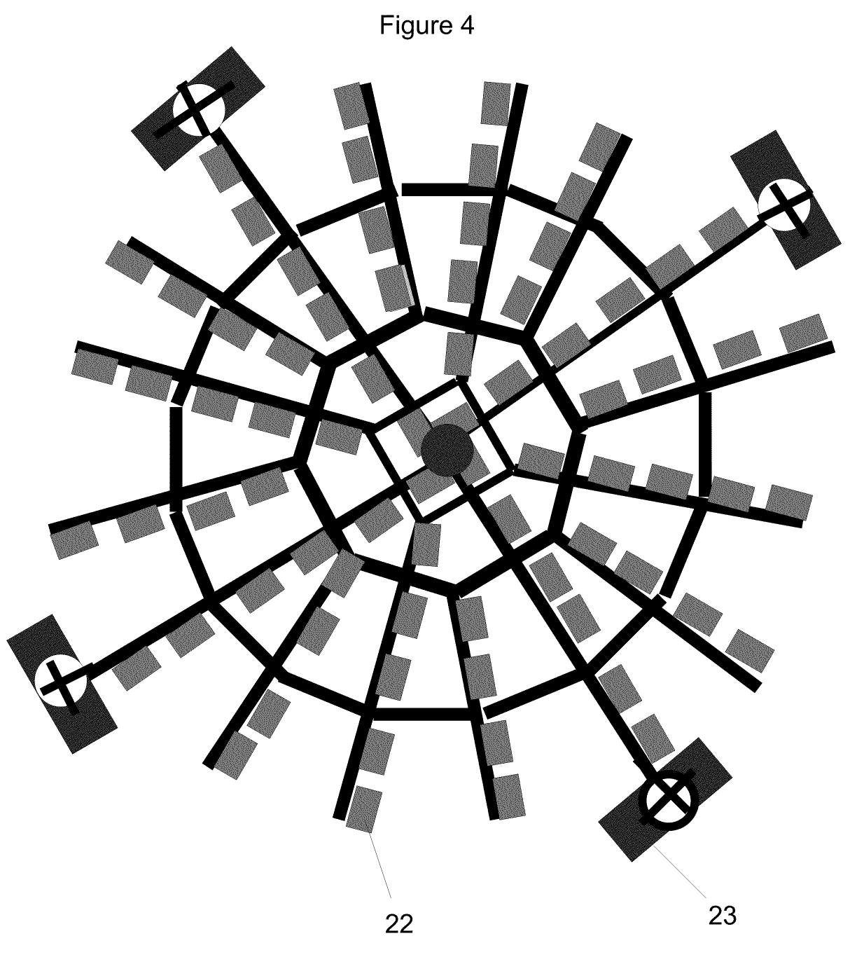

FIG. 4 is a drawing of a top view of an expanded wind machine. It proves claim 12 that by expanding the machine radially, it creates space where more door units can be added and more power created. It also has wheels (23) added for the extra load and stabilization

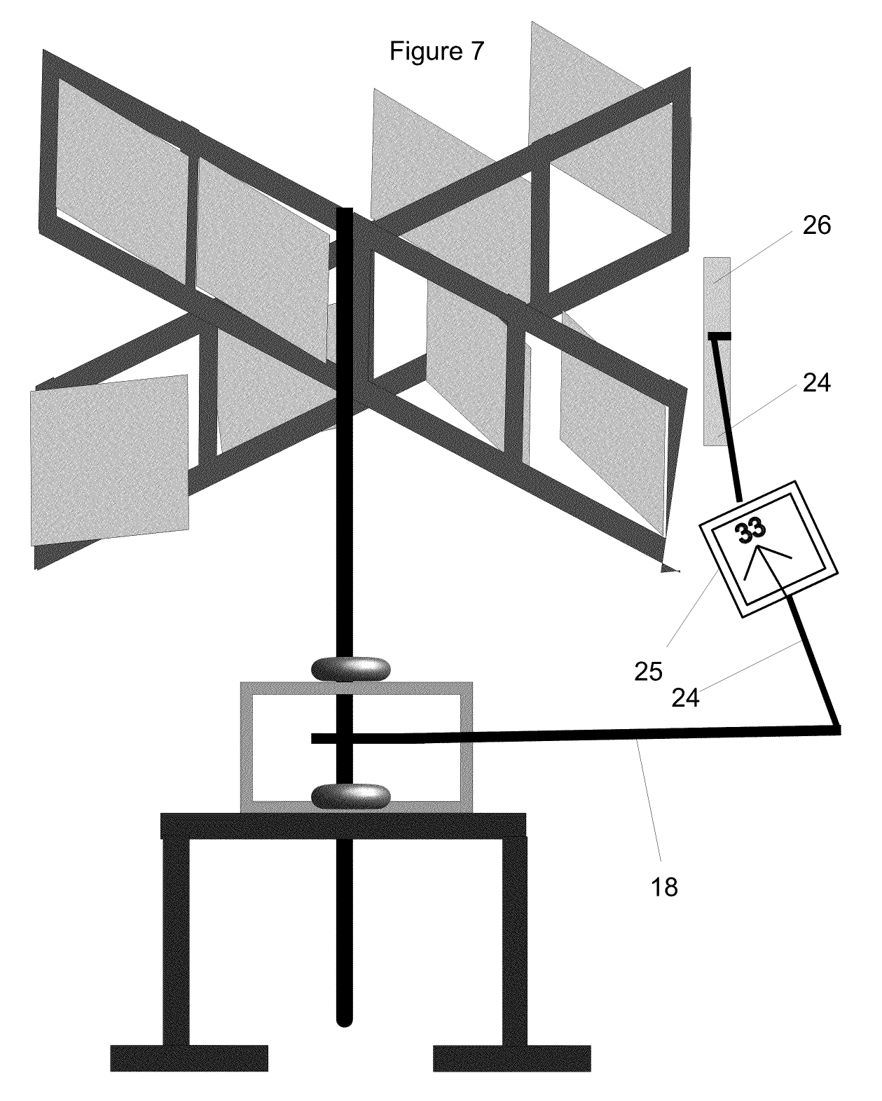

FIG. 7 is a drawing of the, prototype of the wind machine. It was built and tested in wind speeds between 8 mph and 15 mph. These tests were made on the Mississippi Sound near Bayou La Batre Ala. The test results showed a power output of about 2 hp when the wind speed was 15 MPH. The tests were made by using a braking torque of 330 lb/ft on the shaft of the machine. The braking torque was created by applying a pressure of 33 pounds on the shaft of the machine using a 10 foot, ¾ inch, steel, pipe (18). A rope (24) was tied to the end of the pipe and then tied to one end of a spring scale (25). Another rope (24) was tied to the other end of spring scale and then pulled until the scale read 33 lbs. This rope was then tied to a post (26) and the scale remained at 33 pounds during the tests. When the wind speed reached 15 mph the machine speed was recorded at 30 rpm. Using the formula HP=(Torque) (RPM)/5200=(33)(10)(30)/5200=app. 2 HP. The machine was a 2×4 framed structure built around a ½ inch steel pipe. It was unbalanced and wobbled like a top. I believe that most of the power was lost in the load bearings. Being out of balance the doors only opened half the time thereby reducing it's efficiency.

1- A rotating doors wind machine built of doors mounted on a lightweight, strong, frame. The lightweight frame reduces the weight on the load bearings and thereby reduces energy losses through the bearings. The machine runs at a low, constant, speed thereby reducing high speed, centrifugal, damage to its parts. The machine collects wind energy at low wind speeds. The installation cost of the machine is greatly reduced as no large hoisting equipment is needed for installing the wind machine The maintenance and repair costs of the machine is greatly reduced by its lightweight structure. The amount of power generated by the wind machine is unlimited. No positioning mechanism is needed to cause maximum wind force to be directed to it's doors.

2- The rotating doors wind machine as claimed in claim 1, containing a frame made of a lightweight, inexpensive, thin wall, metal built into a truss structure.

3- The rotating doors wind machine as claimed in claim 1, the speed of the machine is held constant by controlling the field of the generator. This is accomplished by armature voltage field excitation or by separate field excitation through a controller using speed feedback.

4- The rotating doors wind machine as claimed in claim 3, the low speed of the machine will keep the drag force low thereby reducing the power losses caused by the drag force.

5- The rotating doors wind machine as claimed in claim 3, the low speed of the machine will reduce are eliminate centrifugal damage to parts of the machine.

6- The rotating doors wind machine as claimed in claim 3, the low speed of the machine will reduce the possibility of damage or death to wildlife.

7- The rotating doors wind machine as claimed in claim 1, can collect wind energy at low wind speeds because of the amount of surface area capability of the doors. This is similar to a sail boat being powered by the wind. A wind speed of 10 mph will drive a 22 foot sailboat with a speed equivalent to a 8 hp, outboard, motor.

8- The rotating doors wind machine as claimed in claim 1, can be erected at minimal cost because of the lightweight parts comprising the machine. No expensive hoisting equipment is needed and most of the assembly can be done by using man power in the hoisting.

9- The rotating doors wind machine as claimed in claim 1, can be maintained and repaired very inexpensively. Mostly on site repairs are necessary, rather than expensive removal and repair at a machine shop or other off site repair facility.

10- The rotating doors wind machine, as claimed in claim 1, can produce more power by adding more vertical sections to the structure.

11- The rotating doors wind machine as claimed in claim 1, can produce more power by lengthening the structure and adding wheels for the structure to rotate on. This will alleviate the weight on the load bearings.

12- The rotating doors wind machine as claimed in claim 1, can produce more power by lengthening the structure and adding more door units in areas created by the lengthening process.

13- The rotating doors wind machine as claimed in claim 1, regardless of the direction the wind force is coming from it will force the doors to open and close for maximum efficiency.
